(19) United States
(12) Patent Application Publication
(10) Pub. No.: US 2017/0243522 A1
(43) Pub. Date: Aug. 24, 2017

(54) RADIATION-FREE SIMULATOR SYSTEMS AND METHODS FOR SIMULATING FLUOROSCOPIC OR OTHER PROCEDURES

(71) Applicant: The University of North Carolina at Chapel Hill, Chapel Hill, NC (US)

(72) Inventors: Richard Harry FEINS, Chapel Hill (US); Hadley Kitchin WILSON, Durham (US); Dumitru Adrian ILIE, Chapel Hill, NC (US)

(21) Appl. No.: 15/453,979

(22) Filed: Mar. 9, 2017

Related U.S. Application Data
(63) Continuation of application No. PCT/US2015/049400, filed on Sep. 10, 2015.
(60) Provisional application No. 62/048,555, filed on Sep. 10, 2014.

(51) Int. Cl. G09B 23/28; G09B 23/30

(52) U.S. Cl. CPC G09B 23/286; G09B 23/285; G09B 23/30

(57) ABSTRACT

Radiation-free simulator systems and methods for simulating fluoroscopic procedures or other medical procedures are provided. Simulator systems, methods and computer readable media are provided, comprising a physical, anatomical model of an anatomy of interest, at least one or more video camera positioned proximate the anatomical model and configured to transmit a live video feed or image of the anatomical model, a computer configured for combining a recorded video feed or 2D rendering of a 3D dataset of an actual anatomical area of interest with the live video feed or image of the anatomical model to form a composite image or video, and a display configured to display the composite image or video. A simulated fluoroscopic procedure can be performed on the anatomical model without radiation, and the simulated fluoroscopic procedure is viewable on the display.

### CROSS-REFERENCE TO RELATED APPLICATIONS

This application is a continuation of and claims priority to PCT/US2015/049400 filed Sep. 10, 2015 which claims the benefit of and priority to U.S. Provisional Application No. 62/048,555, filed Sep. 10, 2014, the entire disclosures of which are incorporated by reference herein.

### TECHNICAL FIELD

The subject matter described herein relates to medical procedures and simulation techniques and systems. More particularly, the subject matter disclosed herein relates to radiation-free simulator systems and methods for simulating fluoroscopic procedures or other medical procedures.

### BACKGROUND

The need for medical training opportunities and the demand for quality control necessitate a consequence-free training environment that allows medical personnel such as physicians to hone their skills before entering a procedure room. This is especially true for radiation-based procedures, such as for example fluoroscopy, where patients and staff are exposed to radiation during some or all of a procedure and where more radiation exposure occurs with the length of the procedure.

Accordingly, there exists a long felt need for simulators that can be used to train medical personnel such as physicians, technicians and nurses on medical procedures such as for example those utilizing radiation.

### SUMMARY

The subject matter disclosed herein provides radiation-free simulator systems and methods for simulating fluoroscopic or other procedures.

This object of the presently disclosed subject matter is achieved in whole or in part by the presently disclosed subject matter, and other objects will become evident as the description proceeds when taken in connection with the accompanying Examples as best described hereinbelow.

### BRIEF DESCRIPTION OF THE DRAWINGS

The presently disclosed subject matter can be better understood by referring to the following figures. The components in the figures are not necessarily to scale, emphasis instead being placed upon illustrating the principles of the presently disclosed subject matter (often schematically). In the figures, like reference numerals designate corresponding parts throughout the different views. A further understanding of the presently disclosed subject matter can be obtained by reference to an embodiment set forth in the illustrations of the accompanying drawings. Although the illustrated embodiment is merely exemplary of systems for carrying out the presently disclosed subject matter, both the organization and method of operation of the presently disclosed subject matter, in general, together with further objectives and advantages thereof, may be more easily understood by reference to the drawings and the following description. The drawings are not intended to limit the scope of this presently disclosed subject matter, which is set forth with particularity in the claims as appended or as subsequently amended, but merely to clarify and exemplify the presently disclosed subject matter.

For a more complete understanding of the presently disclosed subject matter, reference is now made to the following drawings in which:

FIG. 1 is a perspective view of a simulator system comprising an anatomical model;

FIG. 2 is a perspective view of another embodiment of a simulator system comprising an anatomical model;

FIG. 3 is a perspective view of a portion of an embodiment of a simulator system, including a computer and display;

FIG. 4 is an illustration of a graphical user interface (GUI) running on a computer such as in FIG. 3, and that can be used in association with the simulator systems and methods disclosed herein;

FIG. 5 is a perspective view of one example of an anatomical model and that can be used in association with the simulator systems and methods disclosed herein;

FIG. 6 is a perspective view of another example of an anatomical model and that can be used in association with the simulator systems and methods disclosed herein;

FIG. 7 is a perspective view of another example of an anatomical model and that can be used in association with the simulator systems and methods disclosed herein;

FIG. 8 is a perspective view of another example of an anatomical model and that can be used in association with the simulator systems and methods disclosed herein;

FIG. 9 is a front view of an illustration of a pumping mechanism that can be used in association with the simulator systems and methods disclosed herein; and

FIGS. 10 and 11 are schematic illustrations each illustrating a composite image or still shot of a composite video combined from a recorded video feed of an actual anatomical area of interest with a live video feed or image of an anatomical model produced by and used in association with the simulator systems and methods disclosed herein for a simulated fluoroscopic procedure performed without radiation.

### DETAILED DESCRIPTION

The subject matter disclosed herein will be described more fully hereinafter, in which some, but not all embodiments of the presently disclosed subject matter are described. Indeed, the presently disclosed subject matter can be embodied in many different forms and should not be construed as limited to the embodiments set forth herein; rather, these embodiments are provided so that this disclosure will satisfy applicable legal requirements.

The subject matter herein discloses radiation-free simulator systems and methods for simulating fluoroscopic procedures or other medical procedures. The simulator systems and methods disclosed herein are the first to provide a methodology for training in procedures performed for example with fluoroscopy without the exposure to radiation or the use of expensive computerized virtual reality. Training in endovascular procedures, the new percutaneous aortic valves, and navigational bronchoscopy are possible without the risk of radiation exposure. The technology is applicable to any and all procedures requiring fluoroscopy.

Training can be performed using simulator systems and methods in accordance with the disclosure herein without any exposure to the radiation that would normally be utilized in the actual medical procedure that is being practiced or trained for. The use of X-rays, a form of ionizing radiation, requires the potential risks from a procedure to be carefully balanced with the benefits of the procedure to the patient. While physicians always try to use low dose rates during radiation exposing procedures, the length of a typical procedure often results in a relatively high absorbed dose to the patient. Recent advances include the digitization of the images captured and flat panel detector systems, and modern advances allow further reduction of the radiation dose to the patient.

The simulator systems and methods disclosed and envisioned herein can be used to simulate any suitable fluoroscopy dependent medical procedure involving a human or an animal. For example and without limitation, the subject matter herein can be used to simulate fluoroscopic related procedures as fluoroscopy is an imaging technique using a fluoroscope and utilizing X-rays in order to obtain moving images in real time of internal anatomical structures of a patient. A fluoroscope comprises an X-ray source and a fluorescent screen, and a patient or a pertinent portion of the patient is positioned between the X-ray source and the screen. Modern fluoroscopes use the screen with an X-ray image intensifier and CCD video camera which allows the images to be recorded and played on a monitor in real time during the procedure. Simulator systems and methods disclosed and envisioned herein can be used with fluoroscopic procedures including, for example and without limitation: endovascular stent placement; percutaneous valve placement; vena cava filter placement; heart pacemaker placement; thoracic esophageal surgery, including repair of perforation endovascular thoracic aorta surgery; and intraluminal thoracic aorta surgery. Other fluoroscopic related procedures can also be used in association with the simulator systems and methods disclosed and envisioned herein, including for example: investigations of the gastrointestinal tract, including barium enemas, defecating proctograms, barium meals and barium swallows, biliary stent placement, and enteroclysis; orthopedic surgery procedures, such as those to guide fracture reduction and the placement of orthopedic tools; angiograms, such as of the leg, heart and cerebral vessels; placement of a peripherally inserted central catheter (PICC); placement of a weighted feeding tube; urological procedures such as retrograde pyelography; discography, an invasive diagnostic procedure for evaluation for intervertebral disc pathology; and barium swallows. Although fluoroscopic related procedures are disclosed herein, the simulator systems and methods are also envisioned for use in association with any other suitable, non-fluoroscopic procedures.

In one aspect or embodiment, the simulator systems and methods disclosed and envisioned herein utilize a physical, anatomical model constructed to represent and model a pertinent anatomy. The anatomical model can in one aspect be clear but does not have to be entirely clear, and markers or other indicators can be used with portions of the anatomical model and/or portions to be inserted into or used in association with the anatomical model as desired such as for example to provide an indicator of location of such structures using the simulator systems and methods described herein. A user or trainee can perform all or a portion of any suitable medical procedure using the anatomical model and where the procedure involves use of a medical tool or instrument with the anatomical model, such as for example insertion of a catheter or other tool into at least a portion of the anatomical model. Depending upon the procedure for which training is desired, any suitable anatomical model can be designed, constructed and used. One or more video camera or cameras can be used in association with the anatomical model to provide one or more live video feed or feeds of the anatomical model and whatever procedure is being conducted with the anatomical model. The live video feed can be transferred to an interconnected computer, where a generic, previously recorded video clip of the corresponding or matching anatomical portion of the body is digitally imposed or overlaid on top of the live video feed. Instead of the video clip, it is also envisioned that a still image could be laid over the live video feed and used. The composite image, for example made up of both the live video feed and the recorded video clip, can be shown on a display screen such as a high definition monitor. In this manner, a user can perform a training procedure using a tool interacting with the anatomical model such as by insertion into and movement of the tool within the anatomical model, and the tool will be at least partially visible and its movement shown in real time in the composite image on the display screen, thereby providing an extremely realistic view of a real time fluoroscopic procedure and without any of the normal radiation associated with such a procedure if using a fluoroscope or other radiation exposing device. Using the recorded video clip allows for movement of anatomical portions to be shown in the composite image, such as for example pumping movement of a heart and other such motions. Further details are noted in association with the examples described herein.

Characteristics of the two digital images can both be independently adjusted as desired. For example, the opacity of the two digital images can be adjusted as needed on the computer to adjust or enhance the composite image for better realism or other purposes. 2D warping can be used to register the video and live images so that they overlap. Blending of the two images can be accomplished via transparency values for both video and live images. Image processing can be used to make the background and other potentially-distracting features in the live image “disappear” by adjusting image parameters such as the brightness and contrast of the live image, or by applying other appropriate image processing algorithms. The fluoroscopy videos can similarly be adjusted to better match the live images and allow for less noticeable transitions between viewpoints. Masking can be used to avoid seeing other cameras placed about the model, as well as other potentially distracting features of the physical model, such as a frame that holds it in place.

A simulator system and method of the present disclosure can therefore be used to provide training using haptic feedback (via physical models) and visual feedback (via superimposing live imagery and fluoroscopy video). Multiple viewpoints representing the live imagery and the pre-recorded video clips allow visualization from multiple angles. An advantage to using a pre-recorded video feed or clip is that the recorded video clip allows for the screen to show structural movement of any anatomical portions as would occur when such movement or procedure is performed on a real person and using a fluoroscope. An implementation can utilize multiple video cameras positioned as desired, such as by placement along an arc around the anatomical model, and matched videos of a real fluoroscopy captured from approximately the same points of view. The one or more camera or cameras can be in some embodiments mounted on flexible arms, allowing them to change position and orientation and to produce imagery from novel, flexible viewpoints in real-time, closely mimicking a real fluoroscopy. Fiducials (e.g., IR LEDs or physical markers) can be placed and used inside the physical model such as for aiding in the determination of the camera pose in real-time (which can be referred to as tracking). The tracking method does not have to be optical (relying on the live camera images). Instead, other tracking methods can be used, such as magnetic tracking (using magnetic sensors), or even mechanical tracking (using positional sensors such as shaft encoders positioned on the joints of the camera arm). The tracked camera pose can be used to pick the most appropriate video out of a number of available videos, or to blend multiple videos together. 3D rendering can be used to properly warp both the video clip and the live camera image in order to maximize the area they occupy on screen, provide better registration between the video and the live image, and allow for more flexible options when blending them together. A 3D dataset such as a CT scan or MRI can be processed into a “point cloud” that can be made to look like a fluoroscopy image by rendering “slices” through it or using other volumetric rendering techniques. The cameras can also use different imaging modalities, such as infrared, ultrasound, or X-ray, in order to ensure that only the desired features of the physical model are visible in the live camera images.

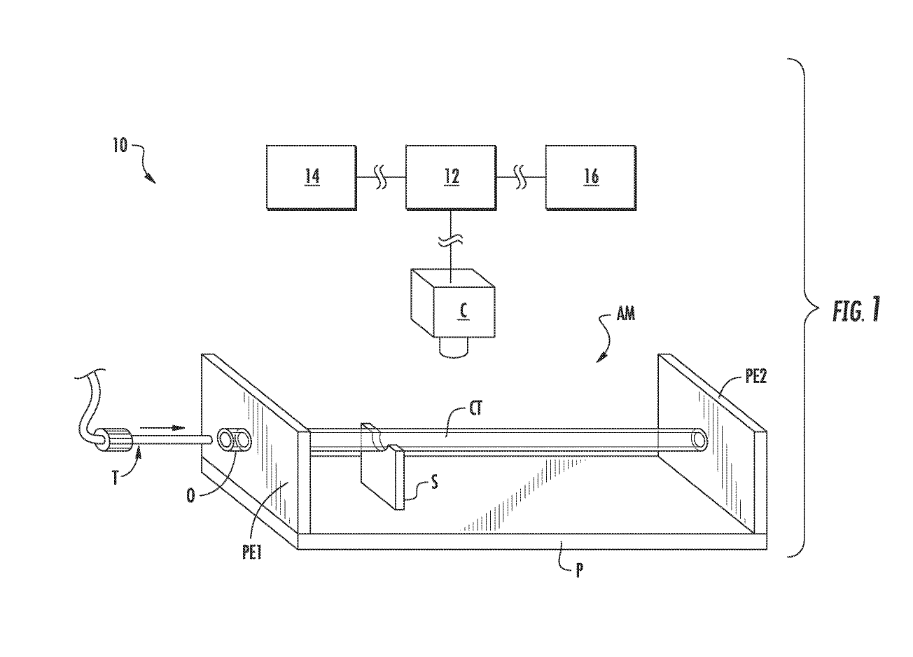

Thus, in a system or method before tracking, the live camera images and the recorded video feed are warped in 2D or 3D to make their features align when overlaying on top of each other. The masking can be used to obscure parts of the live camera images that would show other cameras or undesirable or potentially distracting features of the physical model such as a frame holding it. Masking can also be used to obscure parts of the recorded video feed or loop or 2D rendering of a processed 3D dataset that would show potentially distracting features of the video or 3D dataset such as registration markers or identification text. Blending and other compositing algorithms can be used to take the live camera images and the recorded video feed or loop or 2D rendering of a processed 3D dataset and arrive at a final image presented in real-time to the user. FIG. 1 is a perspective view of a simulator system 10 comprising an anatomical model. Simulator system 10 can in some embodiments be used as a simulation system for use by a user to simulate a fluoroscopy procedure, wherein the simulated fluoroscopy procedure can be conducted without exposing the user to radiation as would be the case with actual fluoroscopy. In some aspects, and as depicted in FIG. 1, simulator system 10 can comprise an anatomical model AM, a camera C, a computer 12 and a display 16.

Anatomical model AM can comprise in some embodiments a plastic tubing 82, such as for example a TYGON® type plastic tube. Whether plastic tubing or other material, the anatomical model AM can be a clear or substantially transparent structure to allow for visualization in the simulator systems and methods disclosed herein. The anatomical model portion AM can include a clear tube CT that can comprise an opening O providing access for a portion of tool T to pass into clear tube CT where manipulation of tool T can occur, such as for example deployment of a stent. In this embodiment, clear tube CT can be attached and supported on a platform P, and can in some aspects include a support S. Platform P can comprise a first platform end PE1 and in some embodiments a second platform end PE2, wherein the first platform end PE1 and/or second platform end PE2 can be configured to support anatomical model portion AM.

Camera C can be positioned or disposed above or otherwise proximate to at least a portion of anatomical model AM to provide a live video feed or other images during use of the simulator system. Particularly, camera C can capture a simulated procedure, e.g. fluoroscopy, as it is occurring within anatomical model AM. Since anatomical model AM is clear, opaque or substantially transparent, camera C can capture videos and/or images of any tools or equipment, such as tool T in FIG. 1 for example, manipulated by a user in a simulated procedure.

Using this anatomical model AM and a tool such as a hand tool T, a user can insert an extended end portion of tool T into an opening O of anatomical model AM. A portion of tool T can pass into clear tube CT where manipulation of tool T can occur, such as for example deployment of a stent.

Camera C can in some embodiments comprise a video camera, still camera or combination thereof. In some embodiments multiple cameras C can be used. Camera C can be used in association with anatomical model AM to provide one or more live video feed or feeds of the anatomical model AM and whatever procedure is being conducted with the anatomical model AM. The live video feed can be transferred to an interconnected computer 12, where a generic, previously recorded video clip 14 of the corresponding or matching anatomical portion of the body is digitally imposed or overlaid on top of the live video feed from camera C. Instead of the video clip, it is also envisioned that a still image could be laid over the live video feed and used. The composite image, made up of both the live video feed and the recorded video clip, can be shown on a display screen 16 such as a high definition monitor. In this manner, a user can perform a training procedure using a tool T interacting with the anatomical model AM such as by insertion into and movement of the tool within the anatomical model AM, and the tool will be at least partially visible and its movement shown in real time in the composite image on the display screen 16, thereby providing an extremely realistic view of a real time fluoroscopic procedure and without any of the normal radiation associated with such a procedure if using a fluoroscope or other radiation exposing device. Using the recorded video clip 14 allows for movement of anatomical portions to be shown in the composite image, such as for example pumping movement of a heart and other such motions.

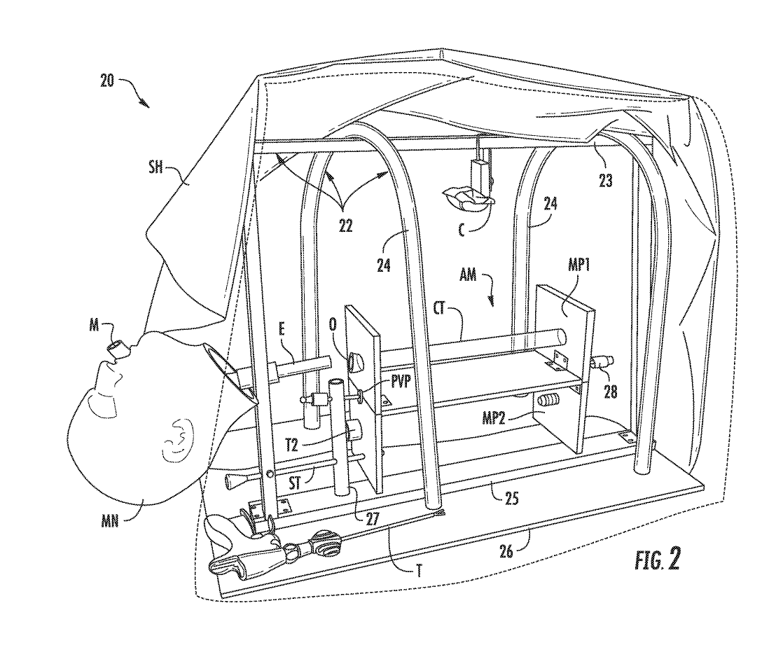

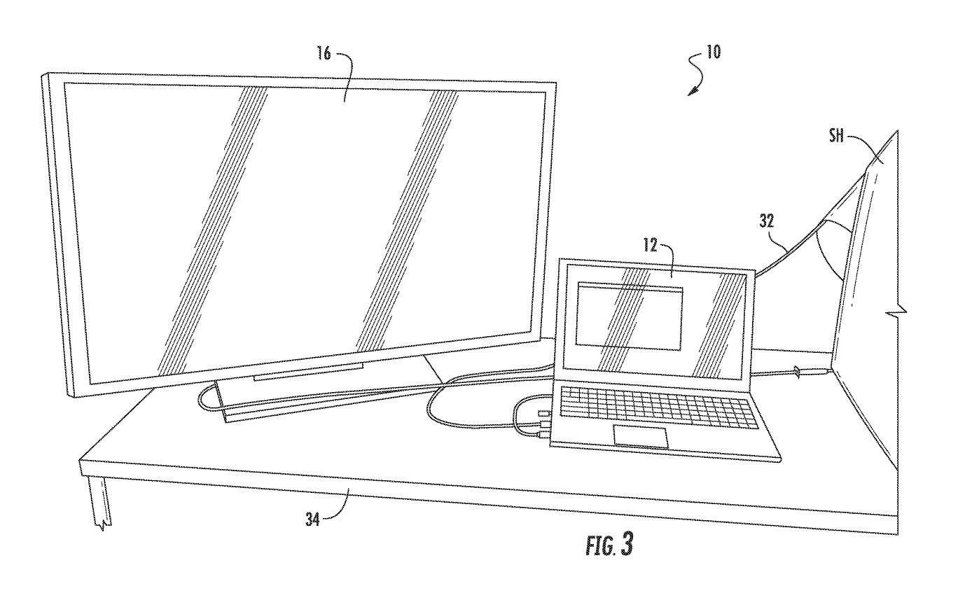

FIG. 2 is a perspective view of another embodiment of a simulator system 20 comprising an anatomical model AM. Simulator system 20 can in some embodiments be used as a simulation system for use by a user to simulate a fluoroscopic procedure, wherein the simulated fluoroscopy can be conducted without exposing the user to radiation as would be the case with actual fluoroscopy. In some aspects, and as depicted in FIG. 1, simulator system 20 can comprise an anatomical model AM mounted on a platform and a camera C positioned proximate to anatomical model AM. Camera C can be connected to a computer and a display as depicted in FIGS. 1 and 3.

Anatomical model AM can comprise in some embodiments a plastic tubing 82, such as for example a TYGON® type plastic tube, and can be configured as modeling any anatomical part or structure desired, and as discussed and shown herein. Whether comprised of plastic tubing or other material, anatomical model AM can be a clear or substantially transparent structure to allow for visualization in the simulator systems and methods disclosed herein. The anatomical model portion AM can include a clear tube CT that can comprise an opening O providing access for a portion of tool T to pass into clear tube CT where manipulation of tool T can occur, such as for example deployment of a stent. The anatomical model AM can include a clear tube CT that can communicate with tubing from a mouth entrance M, in some embodiments on a mannequin MN or other anatomical model of a body part(s), and a portion of tool T can pass into clear tube CT where manipulation of tool T can occur, such as for example deployment of a stent. In some aspects, clear tube CT can attach to or be in communication with mouth entrance M and/or mannequin MN, via an additional tubular component such as a trachea or esophagus E.

In some embodiments, clear tube CT, or any anatomical model AM, can be attached and supported on a movable platform MP that can be rotatable along an axis such as from pivot point PVP. Movable platform MP can comprise a first side MP1 and a second side MP2, either of which can be positioned upwards or proximate to camera C, and/or aligned with mouth entrance M or trachea or esophagus E, by rotating movable platform MP. By having two sides movable platform MP can support two different anatomical models AM that can be selected for a simulation exercise by a user. Support members 28 can provide a pivot point PVP such that movable platform MP can rotate along a horizontal axis.

In some embodiments, movable platform MP can be turned or pivoted so that clear tube CT or another anatomical model AM is no longer in communication with tubing or trachea or esophagus E from mouth entrance M and instead another tube portion T2 can be in communication with tubing or trachea or esophagus E from mouth portion M. In one example, an actual anatomical part, such as a trachea or esophagus or section thereof, can be positioned against and communicate with tube portion T2. Using a real anatomical portion or body part, a user can experience and see what it is like to work with the real body portion. In some aspects, a stabilizer ST can engage movable platform MP, e.g. by sliding, to prevent movable platform MP from rotating or moving until desired. Disengaging stabilizer ST, e.g. by sliding or otherwise removing from movable platform MP allows movable platform MP to rotate as desired.

Camera C can be positioned or disposed above or otherwise proximate to at least a portion of anatomical model AM to provide a live video feed or other images during use of the simulator system. Particularly, camera C can capture a simulated procedure, e.g. fluoroscopy, as it is occurring within anatomical model AM. When anatomical model AM is clear or substantially transparent camera C is able to capture videos and/or images of any tools or equipment, such as tool T in FIG. 1 for example, manipulated by a user in a simulated procedure.

Using this anatomical model AM and a tool such as a hand tool T, a user can insert an extended end portion of tool T into an opening O of anatomical model AM. A portion of tool T can pass into clear tube CT where manipulation of tool T can occur, such as for example deployment of a stent.

Continuing with FIG. 2, simulator system 20 can comprise a frame structure 22 or series of frame components 22 creating a structure or housing over which a sheet SH or other material can be placed or draped. In FIG. 2, a portion of sheet SH is shown in dashed lines so that the remainder of simulator system 20 is visible for this description. Sheet SH can in some embodiments comprise a white sheet or other material to be used during a simulation procedure to advantageously filter, control and use light so that the image resulting from the live video feed can be as desired. Other materials could be used also to filter or control the video feed taken by camera C. Additionally, sheet SH can in some aspects be positioned to obscure a user's direct viewing of the anatomical model AM during a simulation exercise such that observation of the simulation on a display (such as display 16 in FIGS. 1 and 3) as would be the case in a real procedure is required. Sheet SH can be removed when not in use to allow access to other portions of the simulator system 20 for setting up a simulation.

Frame structure 22 can in some aspects comprise a medial support structure 23 extending in some embodiments in a substantially lengthwise direction of the simulator system 20. In some embodiments one or more cross-members 24 can extend in a substantially cross-wise direction relative to medial support structure 23, and can in some aspects comprise a substantially curved upper portion such that they create an arch or other framed structure over anatomical model AM. Medial support structure 23 and cross-members 24 can be adjoined in some embodiments, and together can form a frame structure 22 as depicted in FIG. 2. Medial support structure 23 and cross-members 24 can be affixed to a base structure 26. Medial support structure 23 can also be affixed to a base plate 25 which can itself be affixed to base structure 26. The configuration of frame structure 22 depicted in FIG. 2 is only exemplary, and any configuration of support structures that are configured to support a sheet SH or other concealment mechanism can be used.

Camera C can be suspended from, or otherwise affixed to, frame structure 22, and particularly medial support structure 23. Medial support structure 23, having vertical ends and a horizontal top portion can also be configured to support trachea or esophagus E, mannequin MN, stabilizer ST, and/or support members 28 as depicted in FIG. 2.

Continuing with FIG. 2, camera C can in some embodiments comprise a video camera, still camera or combination thereof. In some embodiments multiple cameras C can be used. Camera C can be used in association with anatomical model AM to provide one or more live video feed or feeds of the anatomical model AM and whatever procedure is being conducted with the anatomical model AM. The live video feed is transferred to an interconnected computer, such as computer 12 in FIGS. 1 and 3, where a generic, previously recorded video clip 14 of the corresponding or matching anatomical portion of the body is digitally imposed or overlaid on top of the live video feed from camera C. Instead of the video clip, it is also envisioned that a still image could be laid over the live video feed and used. The composite image, made up of both the live video feed and the recorded video clip, can be shown on a display screen 16 such as a high definition monitor. In this manner, a user can perform a training procedure using a tool T interacting with the anatomical model AM such as by insertion into and movement of the tool within the anatomical model AM, and the tool will be at least partially visible and its movement shown in real time in the composite image on the display screen 16, thereby providing an extremely realistic view of a real time fluoroscopic procedure and without any of the normal radiation associated with such a procedure if using a fluoroscope or other radiation exposing device. Using the recorded video clip 14 allows for movement of anatomical portions to be shown in the composite image, such as for example pumping movement of a heart and other such motions.

Turning now to FIG. 3, computer 12 and display 16, e.g. a monitor, are illustrated as part of a simulator system as disclosed herein, such as for example simulator system 10 of FIG. 1 and/or simulator system 20 of FIG. 2. Computer 12 and display 16 can be electrically interconnected to one another as well as to a camera C (depicted in FIGS. 1 and 2) of a simulator system. An electrical connection 32, for example, can lead from under sheet SH of a simulator as depicted in FIG. 2. The one or more live video feed or feeds of the anatomical model and whatever procedure is being conducted with the anatomical model can be transmitted from the camera to computer 12 where a generic, previously recorded video clip of the corresponding or matching anatomical portion of the body as is being depicted by the anatomical model AM is digitally imposed or overlaid on top of the live video feed from the camera. Instead of the video clip, it is also envisioned that a still image could be laid over the live video feed and used. The composite image, made up of both the live video feed and the recorded video clip, can be shown on a display screen 16 such as a high definition monitor. In this manner, a user can perform a training procedure using a tool interacting with the anatomical model such as by insertion into and movement of the tool within the anatomical model, and the tool will be at least partially visible and its movement shown in real time in the composite image on the display screen 16, thereby providing an extremely realistic view of a real time fluoroscopic procedure and without any of the normal radiation associated with such a procedure if using a fluoroscope or other radiation exposing device. Using the recorded video clip allows for movement of anatomical portions to be shown in the composite image, such as for example the pumping movement of a heart and other such motions. Thus, in some aspects computer 12 and display 16 can be positioned nearby to simulator system 20 (or system 10 as depicted in FIG. 1), such as for example on a table 34, such that a user of simulator system 20 can view display 16 while performing the simulated procedure.

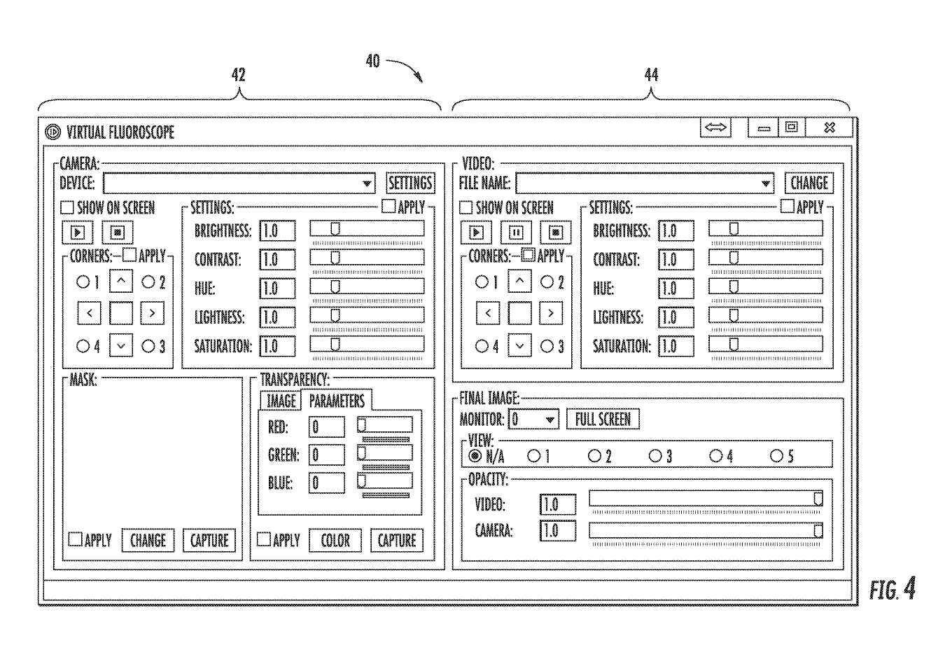

FIG. 4 illustrates an exemplary graphical user interface (GUI) 40 running on a computer such as computer 12 in FIG. 3. GUI 40 can be used in association with the simulator systems and methods disclosed herein, and particularly can provide a user the ability to monitor and adjust settings for the composite image of the live video feed or feeds of the anatomical model and the previously recorded video clip of the corresponding or matching anatomical portion of the body. One portion 42 (left hand side for example) of GUI 40 can be configured to allow for adjustment of the camera in the simulator system (such as camera C depicted in FIGS. 1 and 2), including for example brightness, contrast, hue, lightness, saturation and/or transparency. One portion 44 (right hand side for example) of GUI 40 can be configured to allow for adjustment of the video (pre-recorded video of actual anatomical region of interest) in the simulator system (such as video 14 depicted in FIG. 1), including for example brightness, contrast, hue, lightness, saturation and/or opacity. GUI 40 can in some embodiments provide for optimization of the composite image.

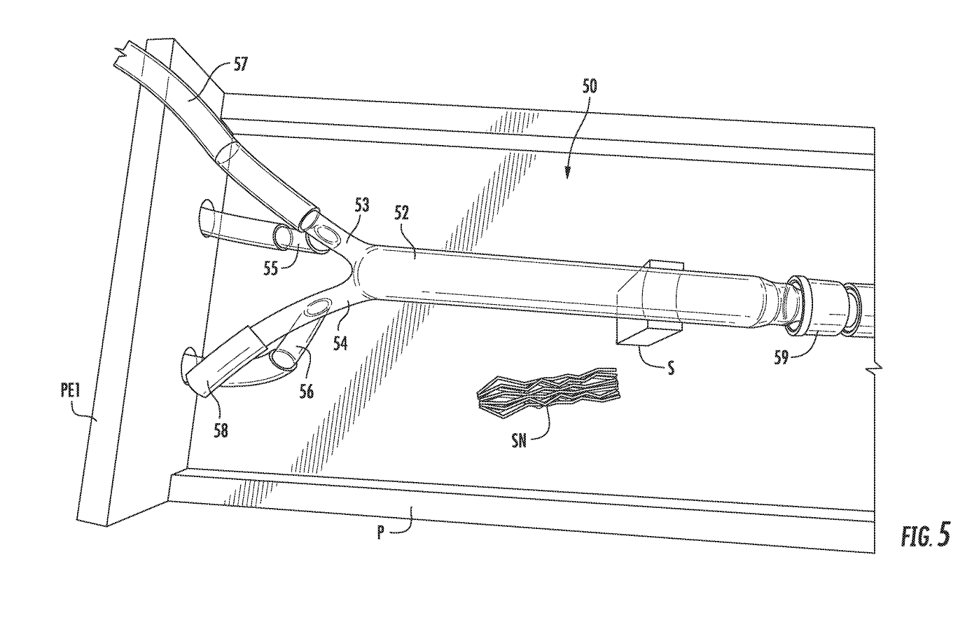

FIG. 5 is a perspective view of one example of an anatomical model that can be used in association with the simulator systems and methods disclosed herein. Anatomical model 50 comprises a clear reconstruction of the abdominal aorta and iliac arteries. Anatomical model 50 can comprise in some embodiments a plastic tubing, such as for example a TYGON® type plastic tube. Whether comprised of plastic tubing or other material, anatomical model 50 can be a clear or substantially transparent structure to allow for visualization in the simulator systems and methods disclosed herein. Anatomical model 50 comprises an abdominal aorta portion 52 and iliac arteries portions 53, 54, 55, 56, 57, and 58. As illustrated in FIG. 5, anatomical model 50 is positioned and resting in platform P (optionally with a support S) with a first platform end PE1 (although not shown here platform P can also comprise a first platform end). One or more portions of iliac arteries portions 53, 54, 55, 56, 57, and 58 can extend past or pass through first platform end PE1 and can be configured to receive a tool or catheter manipulated by a user during a simulation exercise. An exemplary wire-mesh stent SN for insertion into anatomical model 50 is also shown. This allows for the placement of single and fenestrated vascular endografts using simulated multi-angled fluoroscopy. One end (or intermediate portion) of anatomical model 50 can comprise a removable cap 59 for removing a stent SN after a simulated exercise. Anatomical model 50, and variations thereof, can be used in simulation systems as disclosed herein, including those illustrated in FIGS. 1, 2 and 3.

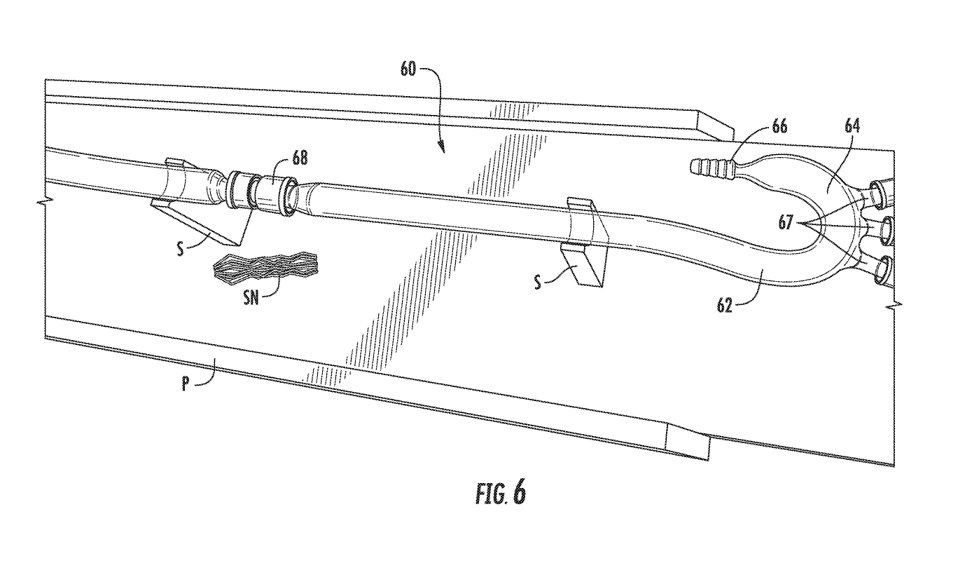

FIG. 6 is a perspective view of one example of an anatomical model that can be used in association with the simulator systems and methods disclosed herein. Anatomical model 60 comprises a clear reconstruction of the thoracic aorta and the aortic root to include the annulus of the aortic valve. Anatomical model 60 can comprise in some embodiments a plastic tubing, such as for example a TYGON® type plastic tube. Whether comprised of plastic tubing or other material, anatomical model 60 can be a clear or substantially transparent structure to allow for visualization in the simulator systems and methods disclosed herein. Anatomical model 60 comprises a thoracic aorta including aortic root with annulus of the aortic valve 66, ascending aorta 64, descending aorta 62, and head vessel branches 67. As illustrated in FIG. 6, anatomical model 60 is positioned and resting in platform P (optionally with a support S). An exemplary wire-mesh stent SN for insertion into anatomical model 60 during a simulated exercise is also shown. In some embodiments, an endograft or endovalve prosthesis can be used in place of or in addition to stent SN. One end (or intermediate portion) of anatomical model 60 can comprise a removable cap 68 for retrieval and reuse of the deployed endograft or endovalve prosthesis. Anatomical model 60, and variations thereof, can be used in simulation systems as disclosed herein, including those illustrated in FIGS. 1, 2 and 3.

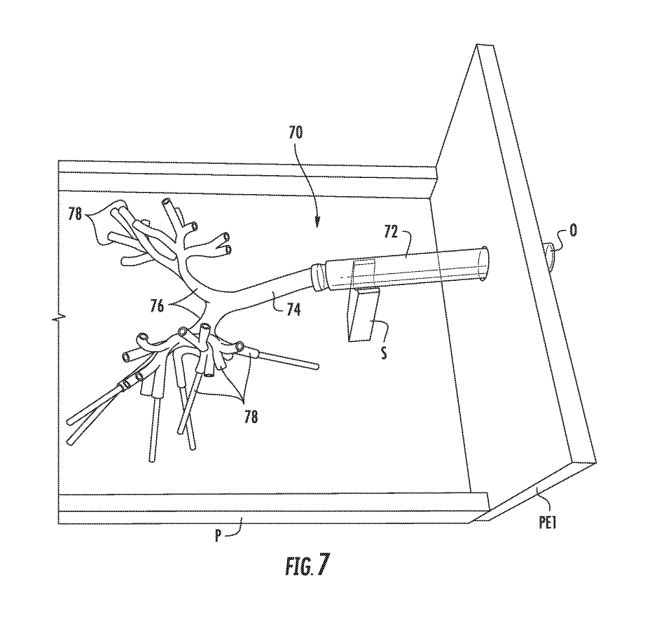

FIG. 7 is a perspective view of another example of an anatomical model that can be used in association with the simulator systems and methods disclosed herein. Anatomical model 70 comprises a clear reconstruction of the lung anatomy. Anatomical model 70 can comprise in some embodiments a plastic tubing, such as for example a TYGON® type plastic tube. Whether comprised of plastic tubing or other material, anatomical model 70 can be a clear or substantially transparent structure to allow for visualization in the simulator systems and methods disclosed herein. Anatomical model 70 as depicted in FIG. 7 comprises a trachea 74, primary bronchi 76, and secondary/tertiary bronchi 78. Tube 72 in some embodiments connects trachea 74 and provides an opening O through which anatomical model 70 can be accessed by a tool or device during a simulated exercise. Tube 72 can in some aspects also be considered trachea 74. As illustrated in FIG. 7, anatomical model 70 is positioned and resting in platform P (optionally with a support S), with in some embodiments a first platform end PE1. A portion of model 70, such as tube 72 can extend past or pass through first platform end PE1 and can be configured to receive a tool or catheter manipulated by a user during a simulation exercise. Anatomical model 70, and variations thereof, can be used in simulation systems as disclosed herein, including those illustrated in FIGS. 1, 2 and 3.

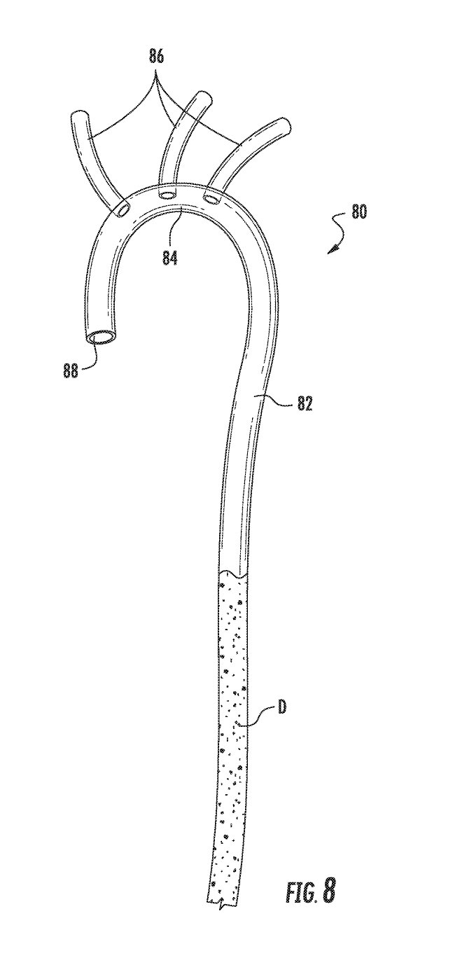

FIG. 8 is a perspective view of an example of an anatomical model 80 that in some embodiments can be used in association with the simulator systems and methods disclosed herein. Anatomical model 80 can in some embodiments comprise a plastic tubing 82, such as for example a TYGON® type plastic tube. Whether comprised of plastic tubing 82 or other material, anatomical model 80 can be a clear or substantially transparent structure to allow for visualization in the simulator systems and methods disclosed herein. In some aspects, anatomical model 80 can comprise a model of the human aorta, as depicted in FIG. 8, including a main body 82, a curved portion 84, and a terminal end 88. In some embodiments anatomical model 80 that is a model of a human aorta can further comprise anatomical features such as great vessels 86. Anatomical model 80, and variations thereof, can be used in simulation systems as disclosed herein, including those illustrated in FIGS. 1, 2 and 3.

In some embodiments, a dye D or other contrast agent or contrast medium can be passed through or placed in anatomical model 80. Dye D can in some aspects comprise a ferromagnetic fluid, such as for example an iron-containing fluid. After each injection or placement in anatomical model 80 the ferromagnetic fluid can be captured using a magnet (or other suitable recovery means) and contained in a reservoir without recirculating to the rest of the simulation system. This can ensure a one time pass of the contrast agent or dye D, which in some embodiments can better simulate a real fluoroscopy technique.

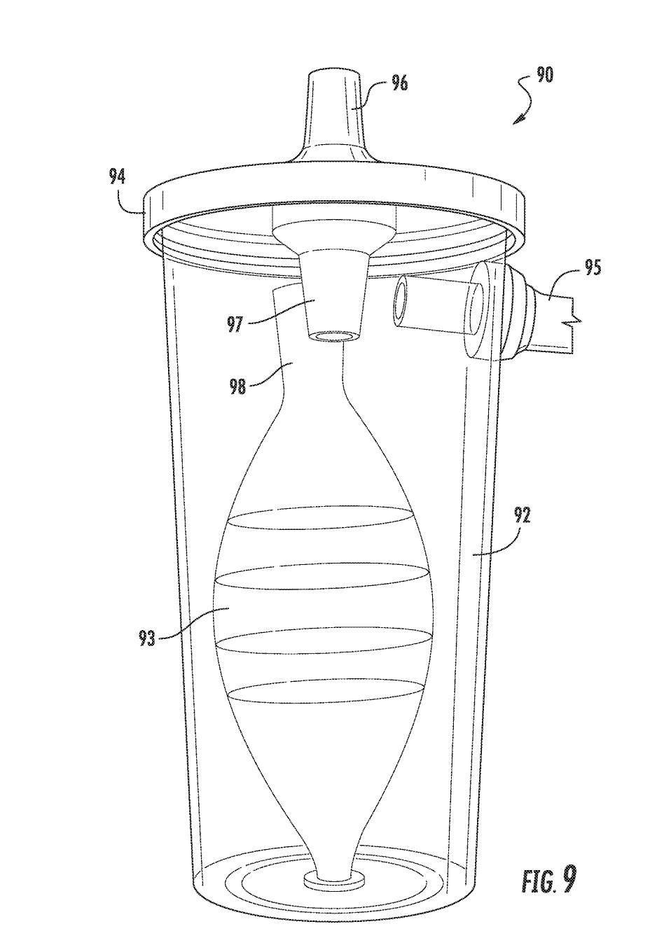

A pumping apparatus 90 or ventricle is illustrated in FIG. 9, which can in some embodiments be used in conjunction with the simulator systems and methods disclosed herein to generate a pulsatile flow of dye D. Pumping apparatus 90 can comprise a vacuum component 93 inside a sealed container 92 to generate a pulsatile flow. Sealed container 92 can comprise a detachable lid 94 comprising an opening with an outer access point 96 and inner access point 97. Sealed container 92 can further comprise a connection point 95 for connection to an anatomical model 80 to create a pulsatile flow therein. Connection between pumping apparatus 90 and anatomical model 80 can be by a tube or other conduit structure.

By combining pumping apparatus 90 and anatomical model 80 (or any of the anatomical models disclosed herein), the tubing system can be filled with a liquid, e.g. water, and a circulation can achieved using pumping apparatus 90. During use in a simulation system, e.g. simulators 10 or 20, a camera can capture an image and/or video of an operator's movement of a tool or catheter through the tubing system and those movements can be rendered onto a monitor/display. The image can then be made transparent and overlaid on top of a prerecorded video of a real chest fluoroscopy for example, creating the illusion and very realistic simulation that the operator's movements are occurring in a real patient actually under fluoroscopy.

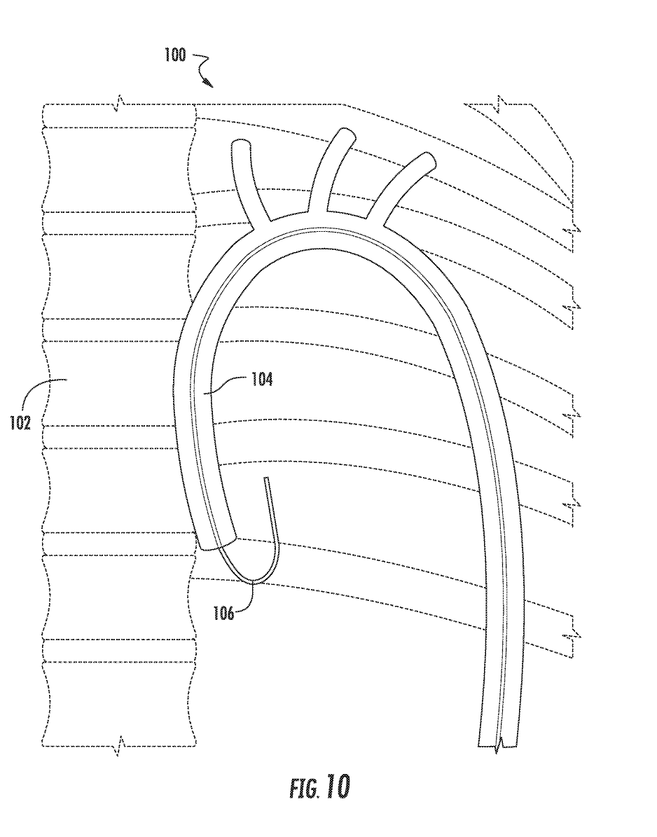

FIG. 10 is a schematic illustrating a composite image or still shot of a composite video combined from a recorded video feed of an actual anatomical area of interest with a live video feed or image of an anatomical model produced by and used in association with the simulator systems and methods disclosed herein for a simulated fluoroscopic procedure performed without radiation. Composite image 100 comprises an image from a recorded video feed 102 of an actual anatomical area of interest (in this example a chest fluoroscopy) combined or overlayed with an image from a live video feed of an anatomical model 104 with a catheter 106 (or other fluoroscopic tool). Dashed lines are used for recorded video feed 102 of an actual anatomical area of interest and solid lines are used for live video feed of an anatomical model 104 with a catheter 106 to illustrate the combination or layering of the two videos/images. When displayed on a display or monitor (such as display 16 in FIGS. 1 and 2) such a composite image/video creates the illusion and very realistic simulation that an operator's movements in a simulation system are occurring in a real patient actually under fluoroscopy.

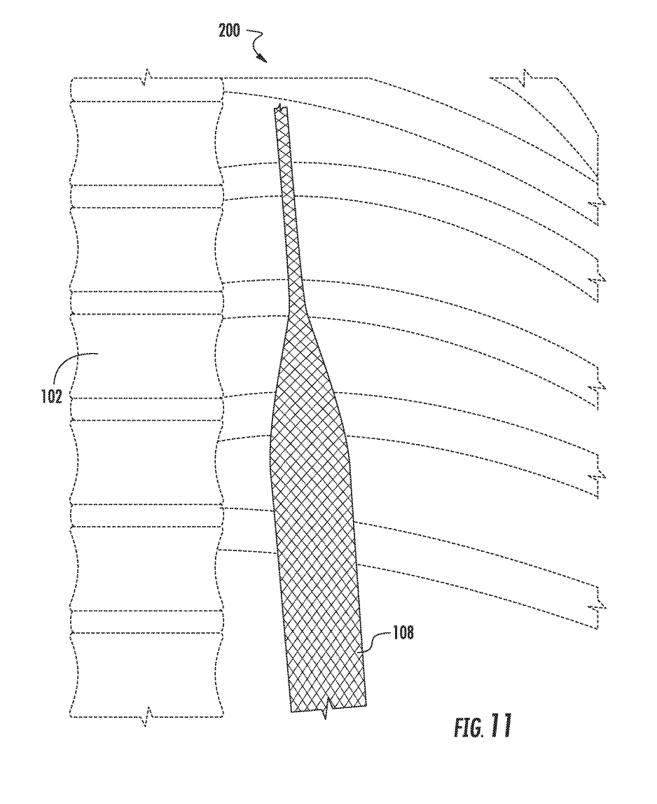

Similar to FIG. 10, FIG. 11 is a schematic illustrating a composite image or still shot of a composite video combined from a recorded video feed of an actual anatomical area of interest with a live video feed or image of an anatomical model produced by and used in association with the simulator systems and methods disclosed herein for a simulated fluoroscopic procedure performed without radiation. Composite image 200 comprises an image from a recorded video feed 102 of an actual anatomical area of interest (in this example a chest fluoroscopy) combined or overlayed with an image from a live video feed of an anatomical model 108. Dashed lines are used for recorded video feed 102 of an actual anatomical area of interest and solid lines are used for live video feed of an anatomical model 108 to illustrate the combination or layering of the two videos/images. When displayed on a display or monitor (such as display 16 in FIGS. 1 and 2) such a composite image/video creates the illusion and very realistic simulation that an operator's movements in a simulation system are occurring in a real patient actually under fluoroscopy.

The subject matter disclosed herein can be implemented in software in combination with hardware and/or firmware. For example, the subject matter described herein can be implemented in software executed by a processor. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

Thus, in some embodiments provided herein is a simulator system comprising a physical, anatomical model of an anatomy of interest, at least one or more video camera or cameras positioned proximate the anatomical model and configured to transmit a live video feed or image of the anatomical model, a computer configured for combining a recorded video feed of an actual anatomical area of interest with the live video feed or image of the anatomical model to form a composite image or video, and a display configured to display the composite image or video. In such a simulator system a simulated fluoroscopic procedure can be performed on the anatomical model without radiation, and the simulated fluoroscopic procedure is viewable on the display, wherein the composite image or video viewable on the display comprises the live video feed or image of the anatomical model during performance of the simulated fluoroscopic procedure combined with the recorded video feed of the actual anatomical area of interest.

In some embodiments, simulator methods are provided, wherein the methods can comprise providing a physical, anatomical model of an anatomy of interest, transmitting a live video feed or image of the anatomical model by at least one or more video camera positioned proximate the anatomical model, and using a computer to combine a recorded video feed of an actual anatomical area of interest with the live video image or feed of the anatomical model. The result is that a simulated fluoroscopic procedure can be performed on the anatomical model without radiation, and the simulated fluoroscopic procedure is viewable on the display, wherein the composite image or video viewable on the display comprises the live video feed or image of the anatomical model during performance of the simulated fluoroscopic procedure combined with the recorded video feed of the actual anatomical area of interest.

In both the simulator systems and methods the anatomical model can comprise a clear anatomical model, such as clear plastic and/or clear glass, including for example a tubing material. The anatomical model can comprise a movable platform and/or be associated with a moveable platform where the platform is movable between different areas of interest. At least one area of interest is configured to be or to support an actual anatomical body portion rather than an anatomical model thereof. An advantage of this simulator system is the anatomical model is not associated with radiation.

The simulator systems and methods can comprise using indicators or markers on the anatomical model and/or on structures or tools inserted into or used with the anatomical model.

The simulator systems and methods can further comprise a filter configured to at least partially cover the anatomical model to filter light in the live video feed or image. The simulator system can further comprise a plurality of fixed or movable video cameras. Moreover, characteristics or features of the live video feed or image and/or of the recorded video feed can be adjustable.

The simulator systems and methods can be configured to adjust characteristics or features of the live video feed or image using camera hardware controls and/or software image processing algorithms. The simulator systems and methods can adjust characteristics or features of the recorded video feed using software image processing algorithms. The recorded video feed can comprise a 2D rendering of a processed 3D dataset of an anatomy of interest, wherein the computer can be configured to overlay or superimpose the recorded video feed over the live video feed or image.

The simulator systems and methods can be configured for use with a procedure for training, and wherein the fluoroscopic procedure that can be simulated can comprise endovascular stent placement, percutaneous valve placement, vena cava filter placement, heart pacemaker placement, thoracic esophageal surgery, including repair of perforation endovascular thoracic aorta surgery, open thoracic aorta surgery, a gastrointestinal tract procedure such as a barium enema, defecating proctograms, barium meals and barium swallows, biliary stent placement, enteroclysis, orthopedic surgery procedures, such as those to guide fracture reduction and the placement of orthopedic tools, angiograms, such as of the leg, heart and cerebral vessels, placement of a peripherally inserted central catheter (PICC), placement of a weighted feeding tube, urological procedures such as retrograde pyelography, discography, or combinations thereof. Accordingly, the anatomical model can comprise a model of an anatomical area associated with any of the above procedures and anatomies.

In some embodiments the simulator systems and methods can be configured to use a ferromagnetic fluid as a contrast medium in the anatomical model during the simulation method. The simulator systems and methods can comprise tracking, wherein tracking comprises placing and using one or more fiducial or fiducials, comprising infrared light emitting diodes (LEDs) or physical markers, inside the anatomical model, wherein the fiducial or fiducials are configured for determining a camera pose in real-time. The tracking can comprise optical tracking, magnetic tracking, and/or mechanical tracking.

Provided herein is also a computer readable medium having stored thereon executable instructions that when executed by the processor of a computer control the computer to perform steps comprising transmitting a live video feed or image of an anatomical model by at least one or more video camera positioned proximate the anatomical model, and using a computer to combine a recorded video feed of an actual anatomical area of interest with the live video image or feed of the anatomical model. A simulated fluoroscopic procedure can be performed on the anatomical model without radiation, and the simulated fluoroscopic procedure is viewable on the display, wherein the composite image or video viewable on the display comprises the live video feed or image of the anatomical model during performance of the simulated fluoroscopic procedure combined with the recorded video feed of the actual anatomical area of interest.

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

The term “comprising”, which is synonymous with “including,” “containing,” or “characterized by” is inclusive or open-ended and does not exclude additional, unrecited elements or method steps. “Comprising” is a term of art used in claim language which means that the named elements are present, but other elements can be added and still form a construct or method within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

With respect to the terms “comprising”, “consisting of”, and “consisting essentially of”, where one of these three terms is used herein, the presently disclosed and claimed subject matter can include the use of either of the other two terms.

As used herein, “significance” or “significant” relates to a statistical analysis of the probability that there is a non-random association between two or more entities. To determine whether or not a relationship is “significant” or has “significance”, statistical manipulations of the data can be performed to calculate a probability, expressed as a “p value”. Those p values that fall below a user-defined cutoff point are regarded as significant. In some embodiments, a p value less than or equal to 0.05, in some embodiments less than 0.01, in some embodiments less than 0.005, and in some embodiments less than 0.001, are regarded as significant. Accordingly, a p value greater than or equal to 0.05 is considered not significant.

### Example

As one example and in one embodiment, a simulator system similar to that depicted in FIG. 2, with an anatomical model similar to that depicted in FIG. 8, was designed and constructed to simulate and train physicians on transcatheter aortic valve replacement. A clear model aorta (FIGS. 5 and/or 8) was constructed to contain a circulating fluid and through which catheters, stents and contrast media could be passed. This was all mounted on a white stage and imaged from above with a camera streaming to a laptop computer. On the computer, the live streaming video feed was combined with a pre-recorded chest fluoroscopy to simulate the operator's movements occurring in a patient undergoing actual fluoroscopy. This resulted in a very realistic simulation (such as depicted in FIG. 10) that provided an inexpensive, consequence-free and radiation-free training device for transcatheter aortic valve replacement.

The description herein describes embodiments of the presently disclosed subject matter, and in some cases notes variations and permutations of such embodiments. This description is merely exemplary of the numerous and varied embodiments. The description or mentioning of one or more representative features of a given embodiment is likewise exemplary. Such an embodiment can typically exist with or without the feature(s) mentioned; likewise, those features can be applied to other embodiments of the presently disclosed subject matter, whether listed in this summary or not.

It will be understood that various details of the presently disclosed subject matter may be changed without departing from the scope of the presently disclosed subject matter. Furthermore, the foregoing description is for the purpose of illustration only and not for the purpose of limitation.

What is claimed is:

1. A simulator system, comprising:
a physical, anatomical model of an anatomy of interest;
at least one or more video camera positioned proximate the anatomical model and configured to transmit a live video feed or image of the anatomical model;
a computer configured for combining a recorded video feed of an actual anatomical area of interest with the live video feed or image of the anatomical model to form a composite image or video; and
a display configured to display the composite image or video,
the simulator system configured such that a simulated fluoroscopic procedure can be performed on the anatomical model without radiation, the simulated fluoroscopic procedure being viewable on the display, wherein the composite image or video viewable on the display comprises the live video feed or image of the anatomical model during performance of the simulated fluoroscopic procedure combined with the recorded video feed of the actual anatomical area of interest.

2. The system of claim 1, wherein the anatomical model comprises a clear anatomical model.

3. The system of claim 2, wherein the anatomical model comprises clear plastic and/or clear glass.

4. The system of claim 2, wherein the anatomical model comprises a tubing material.

5. The system of claim 1, wherein the anatomical model comprises a movable platform and where the platform is movable between different areas of interest.

6. The system of claim 5, wherein at least one area of interest is configured to be or to support an actual anatomical body portion rather than an anatomical model thereof.

7. The system of claim 1, wherein the anatomical model is not associated with radiation.

8. The system of claim 1, further comprising a filter configured to at least partially cover the anatomical model to filter light in the live video feed or image.

9. The system of claim 1, further comprising a plurality of fixed or movable video cameras.

10. The system of claim 1, wherein characteristics or features of the live video feed or image and/or of the recorded video feed are adjustable.

11. The system of claim 1, wherein the recorded video feed comprise a 2D rendering of a processed 3D dataset of an anatomy of interest.

12. The system of claim 1, wherein the computer is configured to overlay or superimpose the recorded video feed over the live video feed or image.

13. The system of claim 1, wherein the simulator system is configured for simulating a fluoroscopic training procedure comprising:
endovascular stent placement; percutaneous valve placement; vena cava filter placement; heart pacemaker placement; thoracic esophageal surgery, including repair of perforation endovascular thoracic aorta surgery; a gastrointestinal tract procedure including a barium enema; defecating proctograms; barium meals and barium swallows; biliary stent placement; enteroclysis; orthopedic surgery procedures, including those to guide fracture reduction and placement of orthopedic tools; angiograms, including angiograms of a leg, heart and cerebral vessels; placement of a peripherally inserted central catheter (PICC); placement of a weighted feeding tube; urological procedures including retrograde pyelography; discography; or combinations thereof.

14. The system of claim 13, wherein the anatomical model comprises a model of an anatomical area associated with endovascular stent placement; percutaneous valve placement; vena cava filter placement; heart pacemaker placement; thoracic esophageal surgery, including repair of perforation endovascular thoracic aorta surgery; a gastrointestinal tract procedure including a barium enema; defecating proctograms; barium meals and barium swallows; biliary stent placement; enteroclysis; orthopedic surgery procedures, including those to guide fracture reduction and placement of orthopedic tools; angiograms, including angiograms of a leg, heart and cerebral vessels; placement of a PICC; placement of a weighted feeding tube; urological procedures including retrograde pyelography; or discography.

15. A simulator method, comprising:
providing a physical, anatomical model of an anatomy of interest;
transmitting a live video feed or image of the anatomical model by at least one or more video camera positioned proximate the anatomical model; and
using a computer to combine a recorded video feed of an actual anatomical area of interest with the live video image or feed of the anatomical model;
whereby a simulated fluoroscopic procedure can be performed on the anatomical model without radiation, and the simulated fluoroscopic procedure is viewable on the display, wherein the composite image or video viewable on the display comprises the live video feed or image of the anatomical model during performance of the simulated fluoroscopic procedure combined with the recorded video feed of the actual anatomical area of interest.

16. The simulator method of claim 15, comprising providing the anatomical model as a clear anatomical model comprising clear plastic and/or clear glass.

17. The simulator method of claim 15, comprising providing the anatomical model as a model comprising tubing.

18. The simulator method of claim 15, comprising using indicators or markers on the anatomical model and/or on structures or tools inserted into or used with the anatomical model.

19. The simulator method of claim 15, wherein providing the anatomical model comprises providing the anatomical model comprising a movable platform, wherein the platform is movable between different areas of interest.

20. The simulator method of claim 19, comprising providing an actual anatomical body portion as at least one area of interest.

21. The simulator method of claim 15, comprising performing the simulated fluoroscopic procedure with the anatomical model and without radiation.

22. The simulator method of claim 15, comprising at least partially covering the anatomical model to filter light in the live video image or feed.

23. The simulator method of claim 15, comprising using a plurality of fixed of movable video cameras.

24. The simulator method of claim 15, comprising adjusting characteristics or features of the live video feed or image using camera hardware controls and/or software image processing.

25. The simulator method of claim 15, comprising adjusting characteristics or features of the recorded video feed using software image processing.

26. The simulator method of claim 15, comprising overlaying or superimposing the recorded video feed over the live video feed or image.

27. The simulator method of claim 15, wherein the simulator system is used to simulate a fluoroscopic procedure comprising:
endovascular stent placement; percutaneous valve placement; vena cava filter placement; heart pacemaker placement; thoracic esophageal surgery, including repair of perforation endovascular thoracic aorta surgery; a gastrointestinal tract procedure including a barium enema; defecating proctograms; barium meals and barium swallows; biliary stent placement; enteroclysis; orthopedic surgery procedures, including those to guide fracture reduction and placement of orthopedic tools; angiograms, including angiograms of a leg, heart and cerebral vessels; placement of a peripherally inserted central catheter (PICC); placement of a weighted feeding tube; urological procedures including retrograde pyelography; discography; or combinations thereof.

28. The simulator method of claim 27, wherein the anatomical model comprises a model of an anatomical area associated with endovascular stent placement; percutaneous valve placement; vena cava filter placement; heart pacemaker placement; thoracic esophageal surgery, including repair of perforation endovascular thoracic aorta surgery; a gastrointestinal tract procedure including a barium enema; defecating proctograms; barium meals and barium swallows; biliary stent placement; enteroclysis; orthopedic surgery procedures, such as those to guide fracture reduction and the placement of orthopedic tools; angiograms, such as of the leg, heart and cerebral vessels; placement of a PICC; placement of a weighted feeding tube; urological procedures such as retrograde pyelography; or discography.

29. The simulator method of claim 15, comprising using a ferromagnetic fluid as a contrast medium in the anatomical model during the simulation method.

30. The simulator method of claim 15, further comprising tracking, wherein tracking comprises placing and using one or more fiducial or fiducials, comprising infrared light emitting diodes (LEDs) or physical markers, inside the anatomical model, wherein the fiducial or fiducials are configured for determining a camera pose in real-time.

31. The simulator method of claim 30, wherein tracking comprises optical tracking, magnetic tracking, and/or mechanical tracking.

32. A computer readable medium having stored thereon executable instructions that when executed by the processor of a computer control the computer to perform steps comprising:
transmitting a live video feed or image of an anatomical model by at least one or more video camera positioned proximate the anatomical model; and
using a computer to combine a recorded video feed of an actual anatomical area of interest with the live video image or feed of the anatomical model;
whereby a simulated fluoroscopic procedure can be performed on the anatomical model without radiation, and the simulated fluoroscopic procedure is viewable on the display, wherein the composite image or video viewable on the display comprises the live video feed or image of the anatomical model during performance of the simulated fluoroscopic procedure combined with the recorded video feed of the actual anatomical area of interest.
